(19) United States
(12) Patent Application Publication
(10) Pub. No.: US 2013/0031727 A1
(43) Pub. Date: Feb. 7, 2013

(54) Multifunction Lug Wrench

(71) Applicant: Khurram Alexander Raza, Garland, TX (US)

(72) Inventor: Khurram Alexander Raza, Garland, TX (US)

(21) Appl. No.: 13/493,150

(22) Filed: Jun. 11, 2012

Related U.S. Application Data
(60) Provisional application No. 61/514,637, filed on Aug. 3, 2011.

(51) Int. Cl. B25B 23/18

(52) U.S. Cl. 7/100

(57) ABSTRACT

A multifunctional lug wrench according to the present invention is a device that can be used to efficiently open the lugs of car wheels with less force required by the operator by utilizing a built-in ratchet. A super bright

LED bulb is mounted on the wrench near the built-in ratchet so that it can illuminate the entire wheel while changing the wheel in the dark, giving the operator the advantage of opening the wheel lug quicker and without any hassle to hold a flashlight. This innovative product can also be used as a flashlight, a tire thumper and a self-defense tool. Variously sized sockets and extension pieces can be stored directly in the device's body, preventing individuals from having to search for the proper sockets in a tool box, garage, or glove compartment.

### REFERENCE TO RELATED APPLICATIONS

This patent application claims the benefit of U.S. Provisional Application No. 61/514,637 filed on Aug. 3, 2011, the disclosure of which is incorporated herein by reference in its entirety.

### BACKGROUND OF THE INVENTION

1. Field of the Invention

The present invention relates to a lug wrench, and more particularly to a multifunctional lug wrench.

2. Description of Related Art

It is sometimes unavoidable to change a wheel and replace with a spare on the roadside due to a puncture of the tire.

Opening a wheel's lugs can be difficult for anyone. Individual can spend a lot of time and exert a lot of energy simply trying to open the wheel, as the wrench has to be removed from the lug after every turn. When trying to do this at night without a flashlight, the wheel nuts might accidentally roll away. Also, if alone, individuals may be unable to hold both a wrench and a flashlight at the same time. Additionally, individuals must first search for the proper sockets which can be scattered about in toolboxes, garages, or glove compartments. Thus, an effective solution is necessary for the aforementioned problems.

### SUMMARY OF THE INVENTION

It is therefore a primary object of the present invention to provide a multifunctional lug wrench that can work like a lug wrench, provide light while changing a wheel, and provide storage space to organize the proper sockets and extension pieces required for the car wheels replacement.

A multifunctional lug wrench according to the present invention is a device that can be used to efficiently open the lugs of car wheels with less force required by the operator by utilizing a built-in ratchet. This innovative product can also be used to open hard-fastened lugs, and used as a flashlight, as well as a self-defense tool if stranded on the road in an unfamiliar area late at night. Variously sized sockets and extension pieces can be stored directly in the device's body, preventing individuals from having to search for the appropriate sockets in a tool box, garage, or glove compartment. Anyone who drives an automobile will appreciate the convenience afforded by this product.

In one preferred embodiment, the lug wrench of the present invention comprises a cylindrical elongated member made from iron or steel, measuring approximately 5 inches in diameter, 1¼ inches wide, and 22 inches in length. The cylindrical elongated member may be made from other materials or in different dimensions. The cylindrical elongated member's body can be hollow and can house a various sized sockets and extension pieces. There can be a flashlight on one end, as well as an internal battery and an on/off switch. A gear ratchet welded into the body of the cylindrical member having a square or hexagon shaped protuberance for attaching to the extension piece and/or a socket with a matching recess for the nuts or bolts on the wheel lug. In one embodiment, there can be rubber grips on each end of the cylindrical member of the lug wrench. An additional super bright LED bulb can be mounted on the wrench that can face the wheel while opening. The LED bulb can be turned on to illuminate the entire wheel while changing the wheel in the dark, giving the operator the advantage of opening the wheel quicker and without any hassle to hold a flashlight.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a diagram of the various parts of the device according to an embodiment of the present invention.

FIG. 2 shows a transparent view of the device wherein the socket and extension pieces stored inside the body of the cylindrical elongated member.

FIG. 3 is an operational side view of the lug wrench assembled in place for use to loosen or tighten a nut or bolt head on a wheel lug.

FIG. 4 shows an operator using the flash light on one end of the device of the present invention to shine on the wheel.

FIG. 5A shows an operator using the lug wrench of the present invention to open or tighten a wheel.

FIG. 5B shows an operator using the lug wrench of the present invention to open or tighten a wheel.

### DESCRIPTION OF THE PREFERRED EMBODIMENT

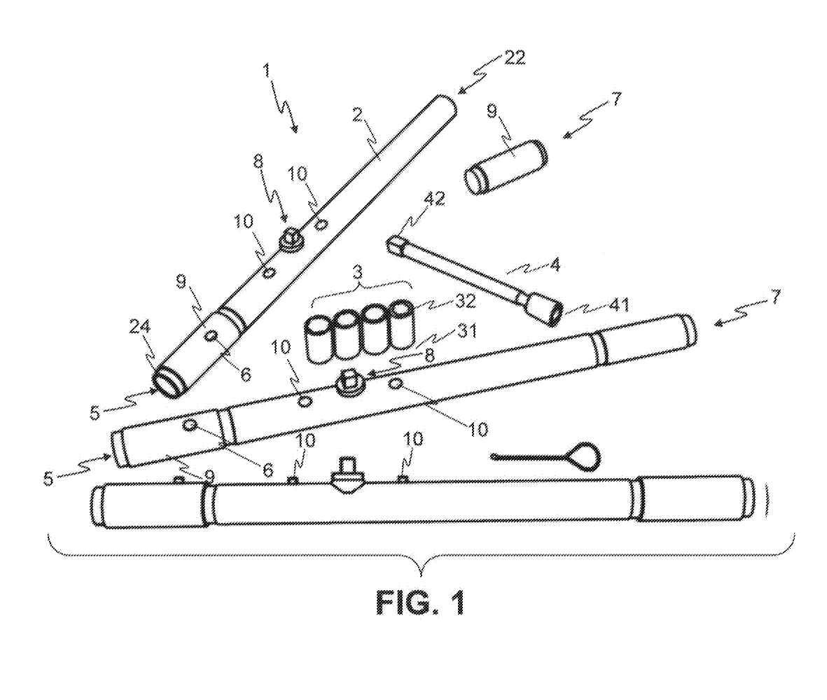

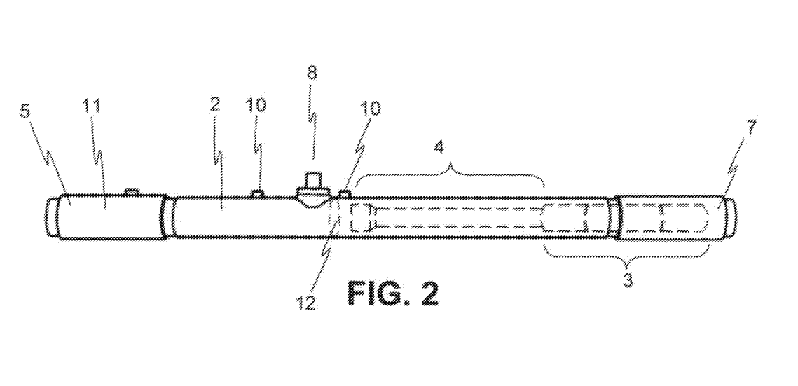

Referring to FIGS. 1 and 2, there is disclosed a multifunctional lug wrench according to an embodiment of the present invention. The multifunction lug wrench 1 is an all-in-one device that can function as a variety of tools, including a wrench, a socket holder, a flashlight, a tire thumper to check the tire's pressure, and a self-defense tool. This multifunctional lug wrench 1 comprises a cylindrical elongated member 2 which may be hollow inside and open on its first end 22 for receiving and housing a plurality of sockets 3 and an extension piece 4, and closed on its second end 24 opposite to its first end 22; and have a holder cap 7 to close the open end 22. The multifunctional lug wrench 1 further comprises a gear ratchet welded into the body of the cylindrical elongated member 2 in approximately the middle of its longitudinal axis. The gear ratchet's attachment protuberance 8, which is in a square shape, stands upright from the longitudinal axis of the cylindrical elongated member 2. The shape of the gear ratchet attachment protuberance 8 may be in other shape, for example, a hexagon shape.

The extension piece 4 being cylindrical and elongated in shape has a square receiving recess (or socket) 41 on one end for receiving the gear ratchet's attachment protuberance 8 so that it can be removably and perpendicularly affixed to the cylindrical elongated member 2 and an attachment protuberance (or protrusion) 42 on the opposite end for receiving a socket selected from a plurality of sockets 3. A plurality of sockets 3 included in the present invention 1 preferably is 17-mm, 19-mm, 21-mm, 23-mm sockets; other sized sockets may be included in the present invention 1. All sockets 3 include an attachment recess 31 of a common size that allows receiving of the gear ratchet's attachment protuberance 8 or the extension piece's protuberance 42. Each socket 3 includes a recess 32 adapted to receive a specific size nut or bolt head on a wheel 100 for purposes of providing a rotational driving torque to the nut or bolt head on a wheel.

The multifunctional lug wrench 1 further comprises rubber grips 9 on each end of the cylindrical elongated member 2 to facilitate a firm grasp when rotating the cylindrical elongated member 2 to loosen or tighten the nuts or bolt heads. The extension piece 4 or sockets 3 may have magnetic material on the internal surface of the receiving recess 41, 31, 32 and protuberance 8, 42 so that the extension piece 4 is adapted for magnetically attaching onto the gear ratchet 8 and a socket 3 of a plurality of such units by a magnetic attraction. The magnetic material may include Neodymium Iron Boron. Thus, the cylindrical elongated member 2 works as a lever around the gear ratchet 8 and socket 3 with or without extension piece 4 for providing a rotational driving torque to loosen and tighten the nut or bolt head 101 on a wheel 100.

In one preferred embodiment, the pipe measures approximately 5 inches in diameter, 1¼ inches wide, and 22 inches in length. The cylindrical elongated member 2 and extension piece 4 are preferably made from iron or steel. The receiving recess on the extension piece and sockets 41, 31, 32 may have various sizes and shapes.

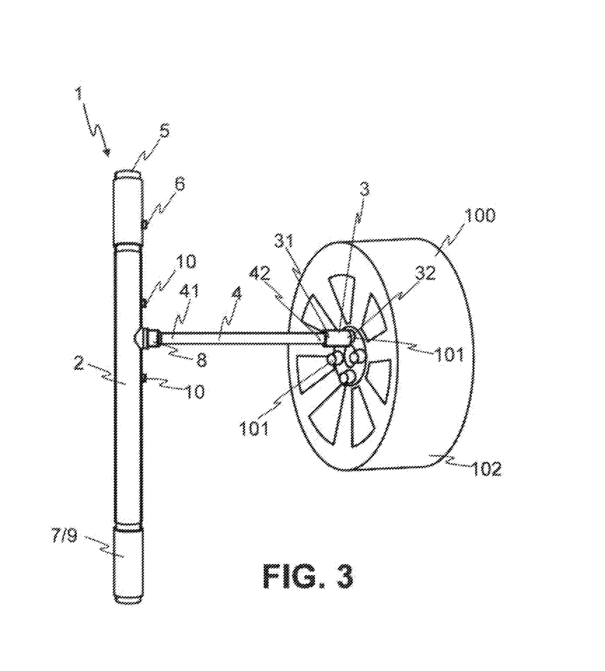

FIG. 3 illustrates an operational side view of the lug wrench of the present invention assembled in place for use to loosen a nut or bolt head 101 from a wheel lug 102 where the extension piece 4 affixes to the gear ratchet's protuberance 8 at its first end 41 and its protuberance 42 is received by the first recess 31 of the socket 3 which further connects to the nut or bolt head 101 on a wheel 100 at its second end 32. Alternatively, the socket 3 may be directly affixed to the gear ratchet's protuberance 8 with its receiving recess 31 and to the nut or bolt head 101 of the wheel with its receiving recess 32 for providing a rotational driving torque to loosen or tighten the nut or bolt head 101 on a wheel 100 without using the extension piece 4. Due to the built-in gear ratchet 8 and the length of the cylindrical elongated member 2, the lug wrench 1 of the present invention can deliver a large amount of force so it can open hard-fastened lugs. The use of the extension piece 4 provides users' access into tight locations. To prevent the extension piece 4 from hitting the LED instrumentality there is an inner separation plate 12 shown in FIG. 1.

Referring now back to FIGS. 1 and 2, the multifunctional lug wrench 1 of the present invention further comprises a flashlight preferably composed of 3 to 4 super bright LED lights 5 which are attached to the closed end 24 of the cylindrical elongated member 2, as well as an internal battery 11 to supply power to the flashlight 5 and an on/off switch button 6 to control the illumination of the flashlight 5. An additional super-bright LED bulb 10 can also be mounted on the cylindrical elongated member 2 near the gear ratchet 8 so that the LED bulb 10 can face the wheel while opening. The light 10 can get its power or energy from the flashlight battery 11 and can be turned on/off by the same button 6. In another embodiment, the light 10 can have its own separate power or energy supply 11 and on/off switch button 6. As seen in FIG. 1 there can be two LED bulbs 10 located on either side of gear ratchet 8. Its function can be to illuminate the entire wheel while changing the wheel in the dark, giving the operator the advantage of opening the wheel quicker and without any hassle to hold a flashlight. The internal battery 11 may be a rechargeable battery. The exact specifications, materials used, and method of use of the multifunctional lug wrench of the present invention may vary upon manufacturing.

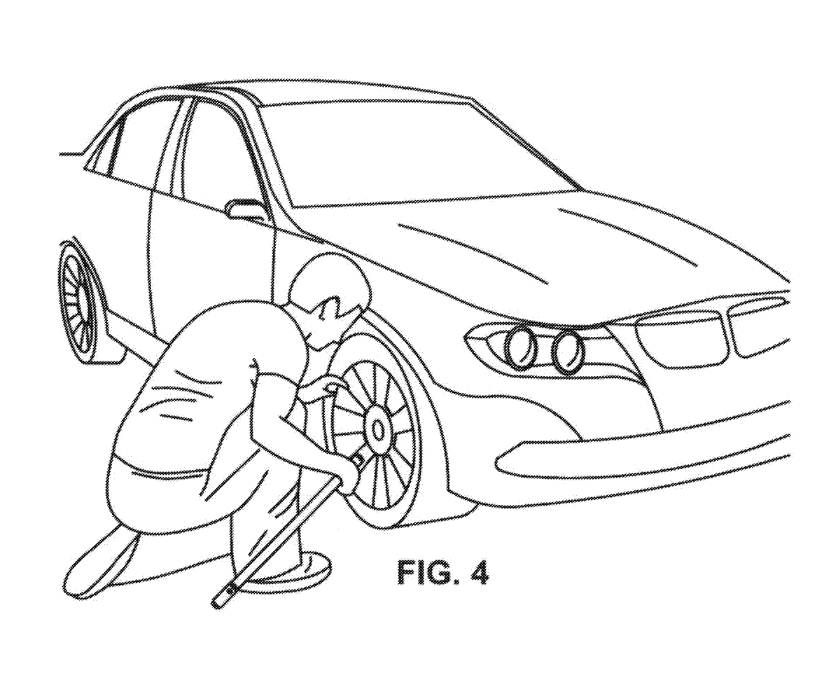

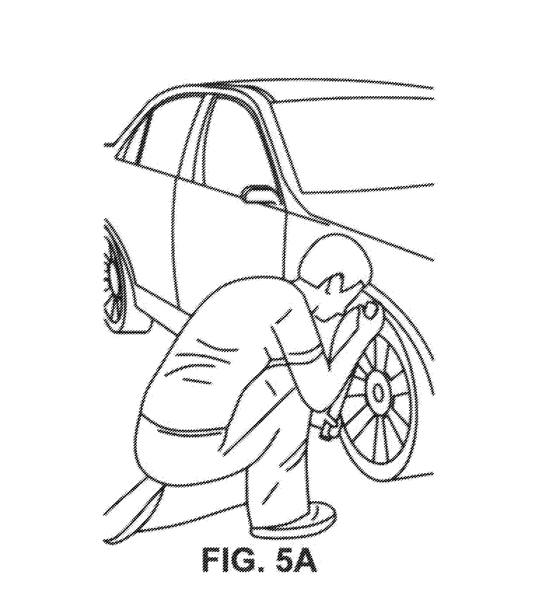

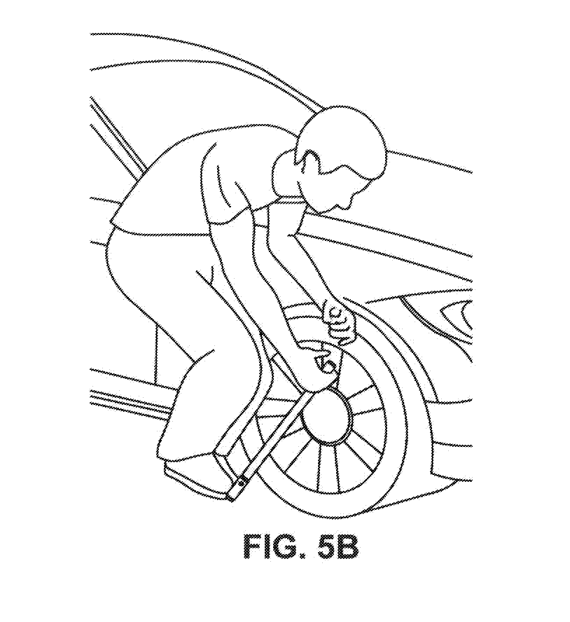

FIG. 4 shows an operator using the flashlight on the closed end of the lug wrench of the present invention to shine on the wheel for examination. FIGS. 5A and 5B show an operator using the lug wrench of the present invention to open a wheel.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A multifunctional lug wrench comprising:
a cylindrical elongated member having a closed end and an open end with a cap, the cylindrical elongated member is hollow inside;
a gear ratchet welded into and stands upright from the cylindrical elongated member having an protuberance end;
an extension piece being in a cylindrical elongated shape having a protuberance on a first end and a receiving recess on a second end for removably receiving the protuberance end of the gear ratchet on the cylindrical elongated member whereby the extension piece can be perpendicularly connected to the cylindrical elongated member;
a plurality of sockets all of which include an attachment recess of a common size on one end that allows removably receiving the protuberance on the gear ratchet or extension piece, and each of which including a recess on the other end adapted to removably receive a specific size nut or bolt head on a wheel;
a flashlight attached to the closed end of the cylindrical elongated member;
a super-bright LED bulb mounted on the cylindrical elongated member close to the gear ratchet so that it can illuminate the wheel while opening;
at least one internal battery located inside the cylindrical elongated member and electrically connected with the flashlight and LED bulb and provide power to the flashlight and LED bulb; and
at least one on/off switch button for controlling the power supply to the flashlight and LED bulb;
wherein the cylindrical elongated member can house the plurality of sockets and extension piece inside when they are not in use.

2. The multiple lug wrench of claim 1 wherein the cylindrical elongated member preferably measuring approximately 5 inches in diameter, 1¼ inches wide, and 22 inches in length.

3. The multiple lug wrench of claim 1 wherein the cylindrical elongated member and extension piece are preferably made of iron or steel.

4. The multiple lug wrench of claim 1 wherein the cylindrical elongated member may have various dimensions or made from various materials.

5. The multiple lug wrench of claim 1 wherein the flashing light preferably having 3 to 4 super bright LED lights.

6. The multiple lug wrench of claim 1 wherein the plurality of sockets preferably includes 17-mm, 19-mm, 21-mm, 23-mm sockets.

7. The multiple lug wrench of claim 1 further comprises rubber grip on both ends of the cylindrical elongated member to facilitate a firm grasp.

8. The multiple lug wrench of claim 1 wherein the extension piece has magnetic material on the surface of the receiving recess and protuberance.

9. The multiple lug wrench of claim 1 wherein the gear ratchet's protuberance and/or sockets' receiving recess have magnetic material on the surface.

10. The multiple lug wrench of claim 1 wherein the protuberance end of the gear ratchet and the extension piece are square shaped and the receiving recess on the second end of the extension piece is square shaped.

11. The multiple lug wrench of claim 1 wherein the protuberance end of the gear ratchet and the extension piece are hexagon shaped and the receiving recess on the second end of the extension piece are hexagon shaped.

12. The multiple lug wrench of claim 1 may have various sized sockets and extension pieces.

13. The multiple lug wrench of claim 1 wherein the internal battery may be a rechargeable battery.
